(19) United States
(12) Patent Application Publication
(10) Pub. No.: US 2024/0046145 A1
(43) Pub. Date: Feb. 8, 2024

(54) DISTRIBUTED DATASET ANNOTATION SYSTEM AND METHOD OF USE

(71) Applicant: TASQ TECHNOLOGIES LTD., Tel Aviv-Yafo (IL)

(72) Inventors: Erez MOSCOVICH, Ramat Hasharon (IL); Nathan CATALAN, Kadima Zoran (IL); Yossi MOTRO, Tel Aviv-Yafo (IL)

(21) Appl. No.: 18/022,152

(22) PCT Filed: Aug. 3, 2021
(86) PCT No.: PCT/IB2021/057069

§ 371 Date: Feb. 19, 2023

Related U.S. Application Data
(60) Provisional application No. 63/067,337, filed on Aug. 19, 2020.

(51) Int. Cl. G06N 20/00; G06Q 30/0207

(52) U.S. Cl. CPC G06N 20/00; G06Q 30/0209; G06Q 30/0277

(57) ABSTRACT

A non-transitory computer readable medium for annotating a dataset, the computer readable medium containing instructions that when executed by at least one processor, cause the at least one processor to perform a method, the method including: dividing a dataset to be annotated into annotating tasks by an annotator engine; distributing the annotating tasks to selected users by a distribution server for completion of the annotating tasks; and reassembling the completed annotation tasks into an annotated dataset.

### FIELD OF THE DISCLOSURE

The present disclosure is of a system and method for annotating of datasets for machine learning models.

### BACKGROUND OF THE DISCLOSURE

Datasets are used in machine learning/deep learning for training and validation of a machine learning model. For machine (computer) vision (CV) and natural language processing (NLP) applications such as self-driving cars, mapping, facial recognition and handwriting recognition datasets include large numbers of labelled data parts such as images and/or videos and/or audio, and/or text. The dataset used generally corresponds with the scope of the application, for example, a dataset including labelled faces will be used to train a facial recognition network where the labels would identify facial features such as eyes, nose, mouth, etc.

Multiple freely available datasets are available for researchers and/or AI application developers. Non-limiting examples of such open datasets include: Common Objects in Context (COCO), ImageNet, Google's Open Images, KITTI and so forth. Commercial datasets can also be purchased. However, developers looking to differentiate their CV application rely on proprietary datasets. Such proprietary datasets are more nuanced than generally available datasets enabling a better focus on the specific needs of the CV application.

Once sufficient data parts have been sourced/collected, the challenge with a proprietary dataset is the labelling, also referred to herein as tagging or annotating of features of interest in the data parts and also verifying that the labelling is accurate. The current approach that is generally used is outsourcing of the annotation to specialist companies employing large numbers of human annotators. There are several disadvantages to this approach:
The associated costs are high;
The skill set of the annotators at a particular company may not match the annotation project requirements requiring use of more than one annotation company each focusing on a specific type of task and resulting in complex combining of the results from multiple companies;
The number of employees is limited, and the annotation project timescales will therefore be limited to the throughput of this limited number of employees;

It would therefore be advantageous to have a system that enables an improved method of dataset annotation to reduce costs, improve the quality of annotation and also the time to provide the quality annotation.

### SUMMARY OF THE DISCLOSURE

The present disclosure overcomes the deficiencies of the background art by providing a system and method for dataset annotation. The system as disclosed herein makes use of existing in-game and in-app advertising and incentivizing systems to provide skilled gaming or application users of the associated games and apps with annotation tasks.

Datasets received by the dataset annotation system (DAS) are divided up into multiple tasks, sub-tasks or micro-tasks and these are then divided between multiple users for annotation. As used herein, the term “tasks” includes sub-tasks and microtasks. This approach creates multiple virtual annotation assembly lines for each dataset with tasks automatically distributed to a large user base having multiple skill sets. Users are provided with incentives for performing annotation in the form of rewards that may be in-game, in-app or provided by 3^{rd}-party merchants. Following performance of annotation tasks, further subtasks or verification tasks are defined based on the previous annotation tasks.

In some embodiments some or all of the tasks are performed by machine learning models and the further verification and correction tasks are based on the output of the models. In some embodiments, the DAS may generate datasets using machine learning techniques, herein referred to as “synthetic” datasets, for testing the DAS process.

Once all of the annotation and verification tasks are completed, the annotation results are assembled into a cohesive annotated dataset to be returned to the client. The approach disclosed herein provides the following advantages:
The number of annotators (users) is potentially vast, making use of existing game and app users as well as dedicated skilled annotators;
The skill set of the potential annotators (garners, app users) is well suited to the tasks of annotation;
Specific users with specific skill sets can be targeted with annotation of micro-tasks further improving the quality of annotation;
The annotation project can be scaled according to the needs of the project including use a more annotators to increase the project throughput;
The ability to divide the annotation task to into micro-tasks performed by a large number of human annotators improves efficiency and reduces human errors

Where reference is used to the term “image” this should also be understood to include video. The term “image dataset” as used herein might refer to a dataset containing a portion of videos or containing only videos.

In some embodiments, a non-transitory computer readable medium for annotating a dataset is provided, the computer readable medium containing instructions that when executed by at least one processor, cause the at least one processor to perform a method, the method including: dividing a dataset to be annotated into annotating tasks by an annotator engine; distributing the annotating tasks to machine learning (ML) models and/or a plurality of selected users by a distribution server for completion of the annotating tasks; and reassembling the completed annotation tasks into an annotated dataset.

In some embodiments, the selected users are playing a game and the annotation task is performed in-game. In some embodiments, the selected users are using an app and the annotation task is performed in-app. In some embodiments, the selected users are using an annotation application. In some embodiments, the annotation application runs on a mobile device.

In some embodiments, the dividing of the dataset is performed by ML models. In some embodiments, the dividing of the dataset is performed manually by an operator of the annotator engine. In some embodiments, the task is a qualification task. In some embodiments, the task is a verification task. In some embodiments, the verification task includes verifying the annotation performed by an ML model. In some embodiments, the selected users are selected based on one or more of user type, user skill sets, or user ratings based on previous tasks completed.

In some embodiments, the task is presented to the selected user as part of in-game advertising. In some embodiments, the task is presented to the selected user as part of in-app advertising. In some embodiments, the same task is assigned to multiple selected users, wherein the annotations of the same task by the selected users are evaluated as a group by the annotation engine. In some embodiments, tasks include microtasks.

In some embodiments, the dataset is provided with dataset requirements selected from the list including: a domain of the dataset, features required, cost constraints, time constraints, user skill set and a combination of the above. In some embodiments, dataset parameters are determined by a campaign manager based on the dataset requirements, wherein the dataset parameters are one or more of user remuneration, time constraints, or maximum number of tasks.

In some embodiments, the method further includes remunerating each of the selected users that completes at least one annotation task. In some embodiments, the user remuneration is an in-game reward. In some embodiments, the user remuneration is an in-app reward.

In some embodiments, the user remuneration is a virtual currency. In some embodiments, the selected user is rated based on a completed task. In some embodiments, the task includes identifying one or more of a visual feature in an image, a visual feature in a video, sounds in an audio file or text styles in a document. In some embodiments, the identifying one or more visual features includes one or more of drawing a polygon, drawing a bounding box, selecting the feature.

In further embodiments a system includes a dataset annotation system (DAS), the DAS further including: an annotator engine configured for dividing a dataset to be annotated into annotating tasks; and a distribution server configured for distributing the annotating tasks to machine learning (ML) models and/or a plurality of selected users for completion of the annotating tasks, wherein the DAS is further configured for reassembling the completed annotation tasks into an annotated dataset.

In some embodiments, the annotation task is performed within games played by the plurality of selected users. In some embodiments, the system further includes an app and wherein the annotation task is performed in-app. In some embodiments, the app runs on a mobile device. In some embodiments, the dividing of the dataset is performed by ML models.

In some embodiments, the dividing of the dataset is performed manually by an operator of the annotator engine. In some embodiments, the task is a qualification task. In some embodiments, the task is a verification task. In some embodiments, the verification task comprises verifying the annotation performed by an ML model. In some embodiments, the dataset is a synthetic dataset. In some embodiments, the selected users are selected based on one or more of user type, user skill sets, or user ratings based on previous tasks completed. In some embodiments, the task is presented to the selected user as part of in-game advertising.

In some embodiments, the task is presented to the selected user as part of in-app advertising. In some embodiments, the same task is assigned to multiple selected users, wherein the annotations of the same task by the selected users are evaluated as a group by the annotation engine. In some embodiments, tasks comprise microtasks. In some embodiments, the dataset is provided with dataset requirements selected from the list including: a domain of the dataset, features required, cost constraints, time constraints, user skill set and a combination of the above. In some embodiments, dataset parameters are determined by a campaign manager based on the dataset requirements, wherein the dataset parameters are one or more of user remuneration, time constraints, or maximum number of tasks.

In some embodiments, each of the selected users that completes at least one annotation task is remunerated. In some embodiments, the user remuneration is an in-game reward. In some embodiments, the user remuneration is an in-app reward. In some embodiments, the user remuneration is a virtual currency. In some embodiments, the selected user is rated based on a completed task. In some embodiments, the task includes identifying one or more of a visual feature in an image, a visual feature in a video, sounds in an audio file or text styles in a document. In some embodiments, the identifying one or more visual features includes one or more of drawing a polygon, drawing a bounding box, and/or selecting the feature.

This Summary is provided to introduce a selection of concepts in a simplified form that are further described below in the Detailed Description below. It may be understood that this Summary is not intended to identify key features or essential features of the claimed subject matter, nor is it intended to be used to limit the scope of the claimed subject matter. The details of one or more implementations are set forth in the accompanying drawings and the description below. Other features will be apparent from the description and drawings.

### BRIEF DESCRIPTION OF THE DRAWINGS

The disclosure is herein described, by way of example only, with reference to the accompanying drawings. With specific reference now to the drawings in detail, it is stressed that the particulars shown are by way of example and for purposes of illustrative discussion of the preferred embodiments of the present disclosure only, and are presented in order to provide what is believed to be the most useful and readily understood description of the principles and conceptual aspects of the disclosure. In this regard, no attempt is made to show structural details of the disclosure in more detail than is necessary for a fundamental understanding of the disclosure, the description taken with the drawings making apparent to those skilled in the art how the several forms of the disclosure may be embodied in practice.

In the drawings:

FIG. 1 is a schematic diagram of a dataset annotation system according to at least some embodiments;

FIGS. 2A-2C show a flow diagram and related screenshots describing the operation of a dataset annotation system according to at least some embodiments; and

FIGS. 3A-3L are exemplary screenshots related to the dataset annotation system according to at least some embodiments.

### DESCRIPTION OF THE PREFERRED EMBODIMENTS

Reference will now be made in detail to non-limiting examples of dataset annotation implementations which are illustrated in the accompanying drawings. The examples are described below by referring to the drawings, wherein like reference numerals refer to like elements. When similar reference numerals are shown, corresponding description(s) are not repeated, and the interested reader is referred to the previously discussed figure(s) for a description of the like element(s).

Aspects of this disclosure may provide a technical solution to the challenging technical problem of dataset annotation and may relate to a system for annotating of datasets for machine learning models with the system having at least one processor (e.g., processor, processing circuit or other processing structure described herein), including methods, systems, devices, and computer-readable media. For ease of discussion, example methods are described below with the understanding that aspects of the example methods apply equally to systems, devices, and computer-readable media. For example, some aspects of such methods may be implemented by a computing device or software running thereon. The computing device may include at least one processor (e.g., a CPU, GPU, DSP, FPGA, ASIC, or any circuitry for performing logical operations on input data) to perform the example methods. Other aspects of such methods may be implemented over a network (e.g., a wired network, a wireless network, or both).

As another example, some aspects of such methods may be implemented as operations or program codes in a non-transitory computer-readable medium. The operations or program codes may be executed by at least one processor. Non-transitory computer readable media, as described herein, may be implemented as any combination of hardware, firmware, software, or any medium capable of storing data that is readable by any computing device with a processor for performing methods or operations represented by the stored data. In a broadest sense, the example methods are not limited to particular physical or electronic instrumentalities, but rather may be accomplished using many differing instrumentalities.

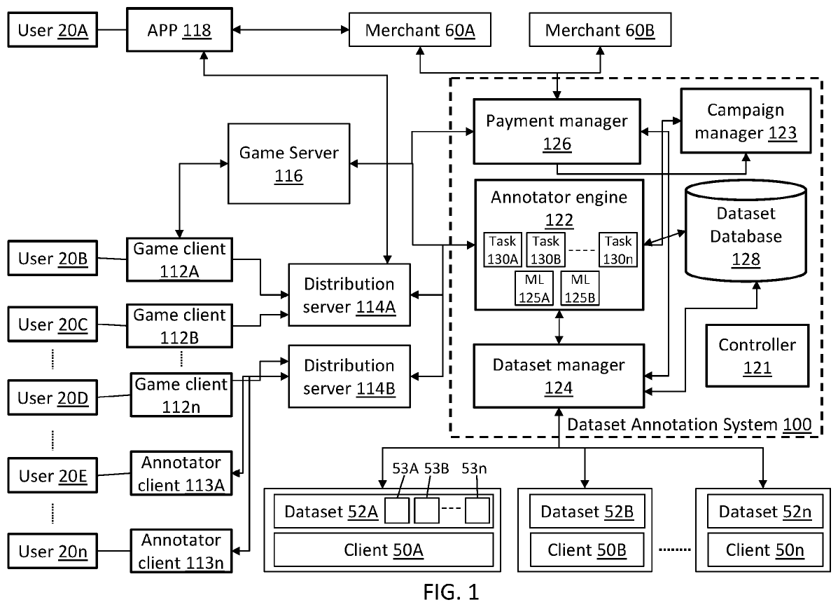

The present invention is of a system and method for dataset annotation. Reference is now made to FIG. 1 showing a dataset annotation system according to at least some embodiments. As shown in FIG. 1, a dataset annotation system (DAS) 100 may include an annotator engine 122, a campaign manager 123, a dataset manager 124, a payment manager 126 and/or a dataset database 128. These components of DAS 100 may be software or hardware modules running on one or more computing devices.

DAS 100 and the modules and components that are included in DAS 100 may run on a single computing device (e.g., a server) or multiple computing devices (e.g., multiple servers) that are configured to perform the functions and/or operations necessary to provide the functionality described herein. While DAS 100 is presented herein with specific components and modules, it should be understood by one skilled in the art, that the architectural configuration of DAS 100 as shown is may be simply one possible configuration and that other configurations with more or fewer components are possible. As referred to herein, the “components” of DAS 100 may include one or more of the modules or services shown in FIG. 1 as being included within DAS 100.

Clients 112 and 113 can be of varying type, capabilities, operating systems, etc. For example, clients 112 and 113 may include PCs, tablets, mobile phones, laptops, virtual reality or augmented reality glasses or other wearables, holographic interfaces, or any other mechanism that allows for user interaction with the platform.

DAS 100 may include a controller service 121. Controller service 121 may manage the operation of the components of DAS 100 and may direct the flow of data between the components of DAS 100. Where DAS 100 may be said herein to provide specific functionality or perform actions, it should be understood that the functionality or actions are performed by controller service 121 that may call on other components of DAS 100 and/or external systems 116, 114

The overall functionality of DAS 100 components is as follows:
annotator engine 122: may break datasets 52 into tasks 130 for annotation and verification by users 20 and/or ML models 125, reassembles datasets;
campaign manager 123 may manage dataset requirements such as budget and time constraints and selects and evaluates users 20 and remuneration options for completing dataset 52 annotation;
dataset manager 124 may manage datasets 52 from clients 50, and provide a front end to clients 50 for describing features to be annotated. In some embodiments, dataset manager 124 may generate synthetic datasets using ML techniques;
payment manager 126 may provide rewards/remuneration for users 20 who have performed annotation/verification; and
dataset database 128 may be used for storage of datasets 52, tasks 130, user ratings, and related data.

The functionality of DAS 100 components will be further understood with reference to the description of components of DAS 100 below.

DAS 100 may interface with multiple external or associated systems. Clients 50 provide datasets 52 including one or more data parts 53 (here shown as 53A-53n). Data parts include images, videos, audio files, and/or text files/documents. Datasets 52 are provided to DAS 100 for annotation of the data parts 53 therein. Three clients 50A, and 50n are shown for simplicity although it should be appreciated that any suitable number of clients may be supported by DAS 100. The term client 50 as used herein refers to the computing devices of a client of DAS 100 using DAS 100 for the purposes of annotating a dataset 52. Dataset manager 124 provides a front-end user interface (not shown) such as a web interface for uploading and definition of the dataset 52 annotation requirements by client 50.

Three datasets 52A, 52B, and 52n are shown for simplicity although it should be appreciated that any suitable number of datasets 52 may be supported by DAS 100. Further, although one dataset 52 per client 50 is shown, any of clients 50 may provide more than one dataset 52.

Annotator engine 122 may break and package dataset 52 into annotation tasks 130 that are provided to distribution server 114 in a suitable format for use by distribution server 114. Tasks 130 include tasks, subtasks and microtasks. Non-limiting examples of the division of tasks and microtasks include:
Where the task is annotation of human body parts in images of humans, microtasks include selecting specific anchor points such as right eye, left ear, left shoulder, etc.;
Where the task is annotation of car license plates in images of vehicles, microtasks include answering questions (are cars visible in the image? are the license plates of the car fully visible?), place a bounding box on the license plate, given a zoom in image of only the license plate—place a bounding box around each letter of the license plate.

Annotator engine 122 operates according to project parameters defined by campaign manager 123 such as maximum remuneration, maximum tasks to allocate, time till completion, and skill requirements of users 20. Distribution server 114 is adapted to provide in-game and in-application advertising and task distribution. As proposed herein, distribution server 114 provides the tasks 130 for annotation or verification, as received from annotator engine 122, to users 20 in place of advertising messages and/or as tasks to be performed.

The tasks 130 are provided to game clients 112 for in-game annotation, or to merchant applications (apps) 118 for in-app annotation or to annotator client 113 for users 20 performing annotation tasks not within the framework of a game 112 or another app 118 or to ML models 125. Users 20 play games using game clients 112 or use apps 118. Annotator clients 113 include dedicated hardware or software for performing annotation. Game clients 112, apps 118, and annotator clients 113 run on computing devices as defined herein. In some embodiments, any or all of game clients 112, apps 118, and annotator clients 113 are mobile devices.

Payment manager 126 interfaces with merchants 60 game servers 116 and annotator clients to provide rewards and/or remuneration (herein referred to as “rewards”) to users 20 that perform annotation/verification.

Two merchants 60A and 60B are shown for simplicity although it should be appreciated that any suitable number of merchants 60 may be supported by DAS 100. Six users 20A, 20B, 20C, 20D, 20E, and 20n are shown for simplicity although it should be appreciated that any suitable number of users 20 may be supported by DAS 100. One user 20A is shown as a user of app 118, three users 20B-20D are shown as users of game clients 112, and two users 20E, 20n are shown as users of annotator clients 113, but it should be appreciated that a different distribution of annotator clients 113, apps 118 and games clients 112 to users 20 may be provided. Further, a user 20 may use any or all of an app 118, annotator client 113, and a game 112. Only one game server 116 is shown for simplicity although it should be appreciated that any suitable number of game servers 116 may be supported by DAS 100.

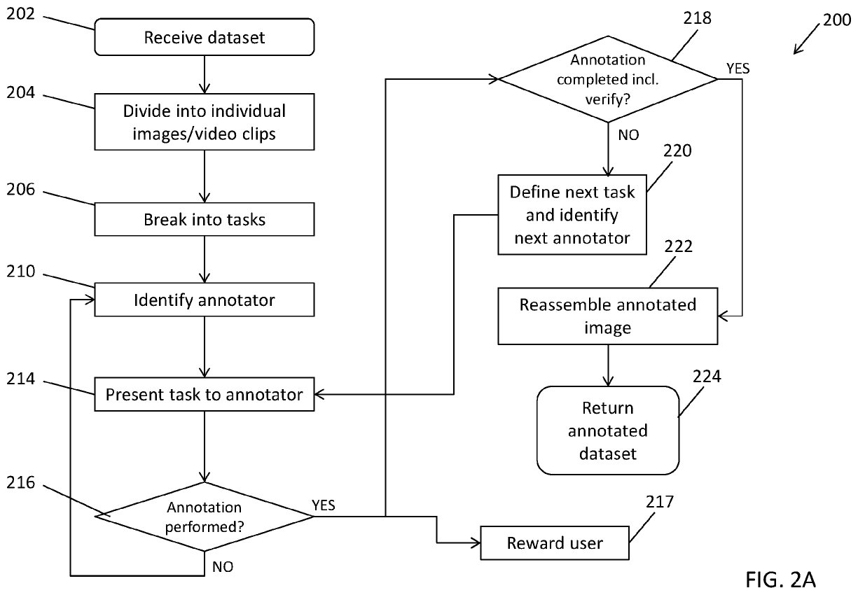

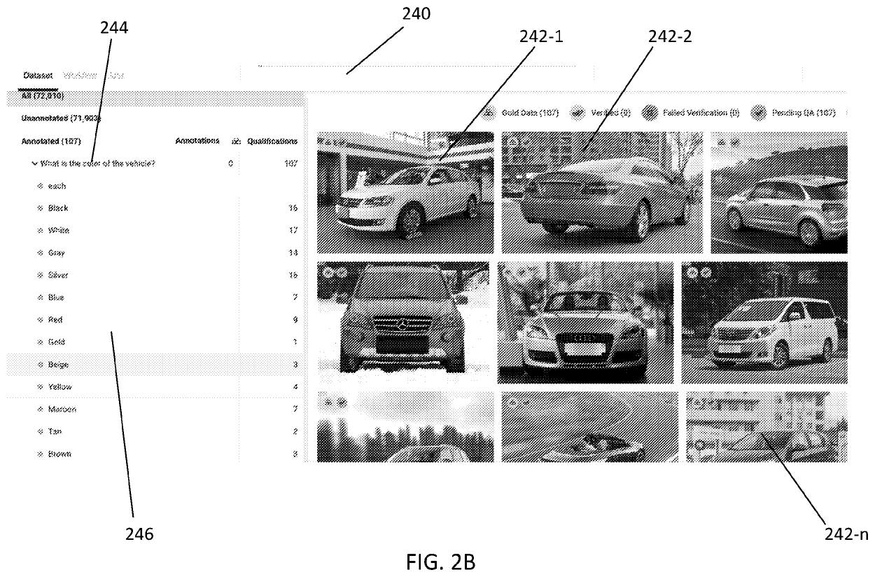

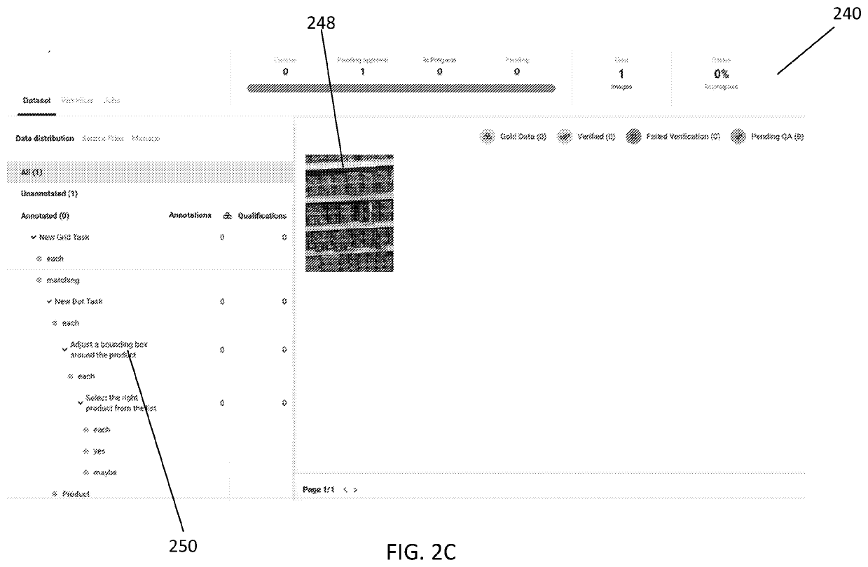

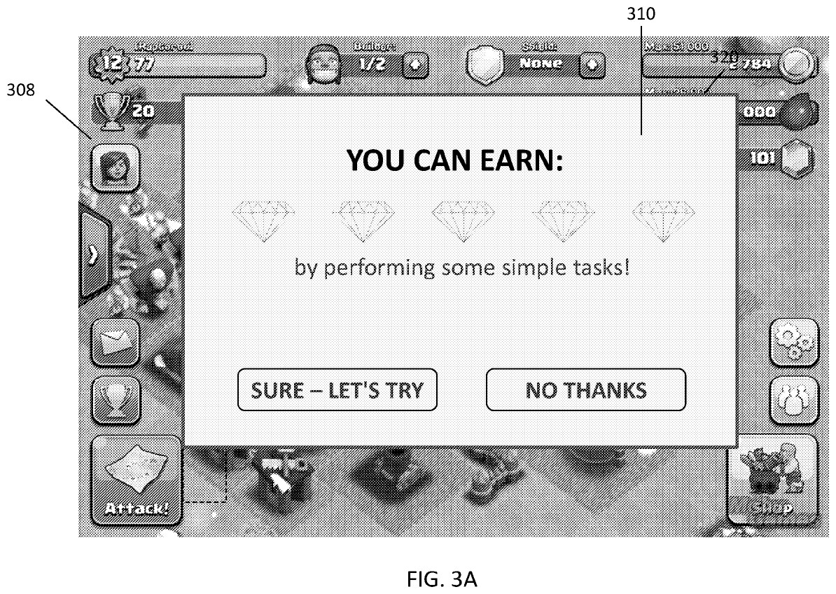

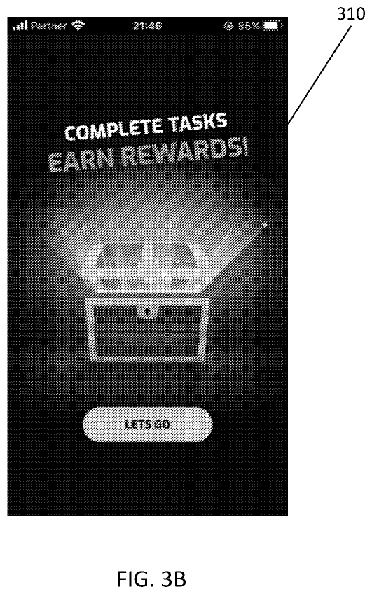

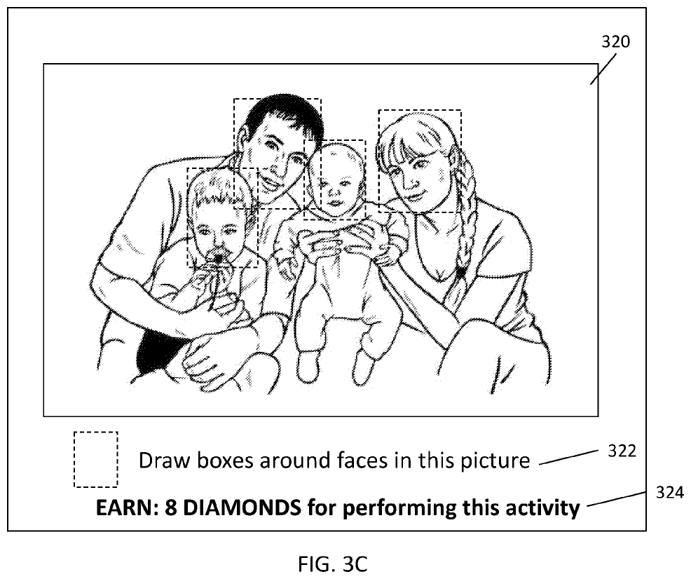

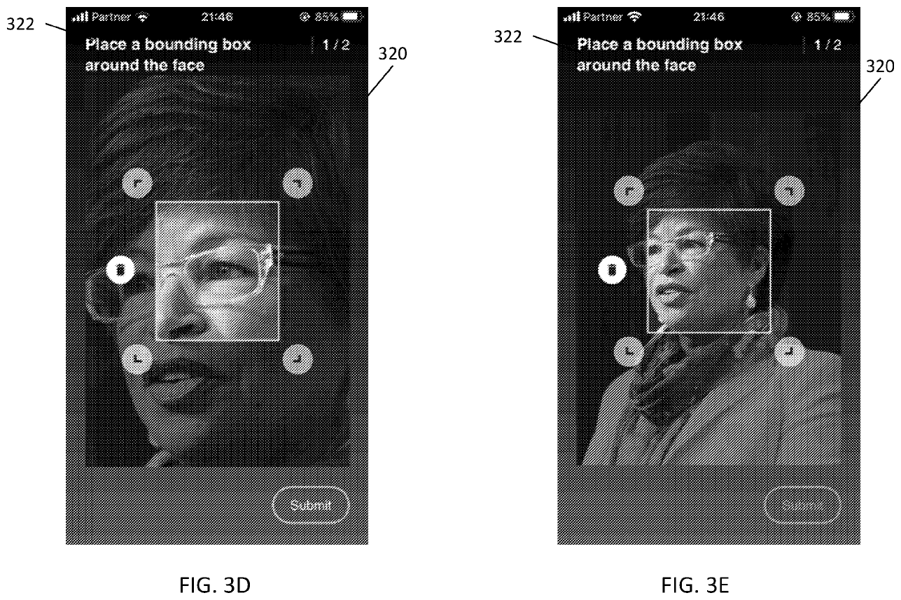

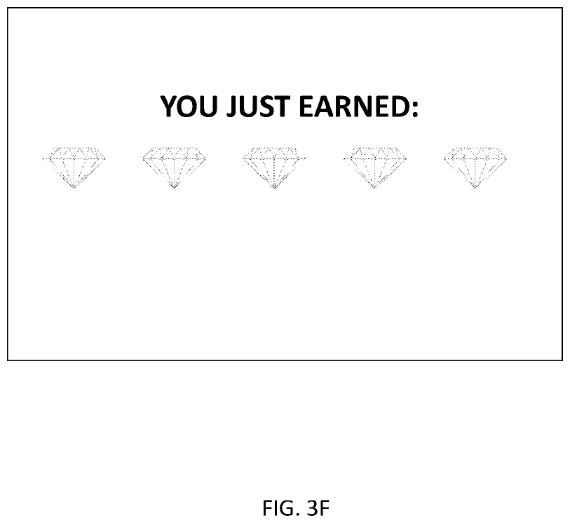

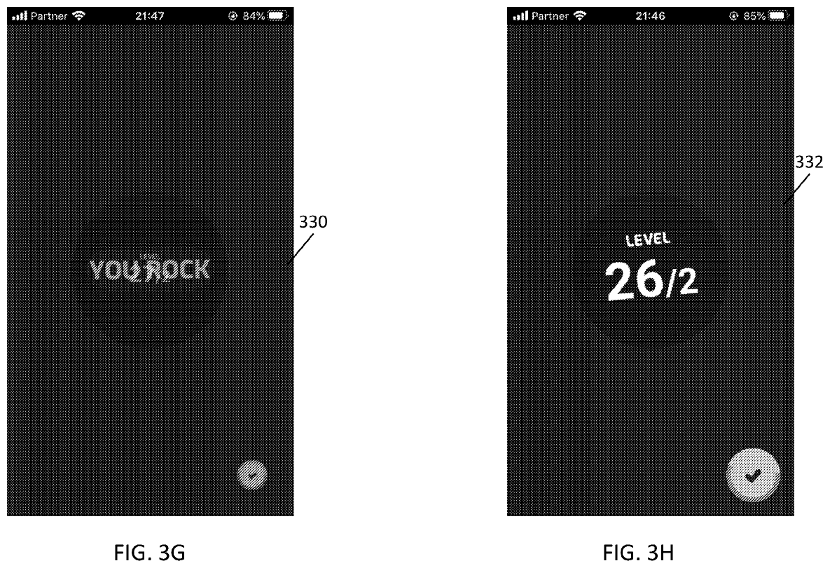

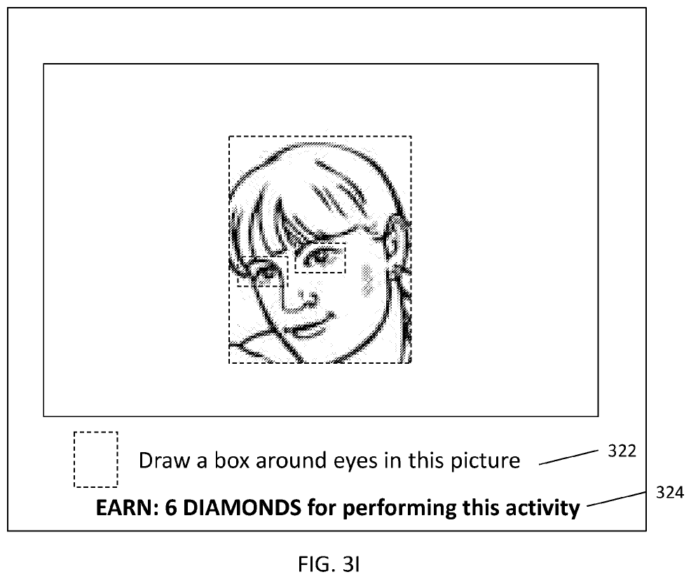

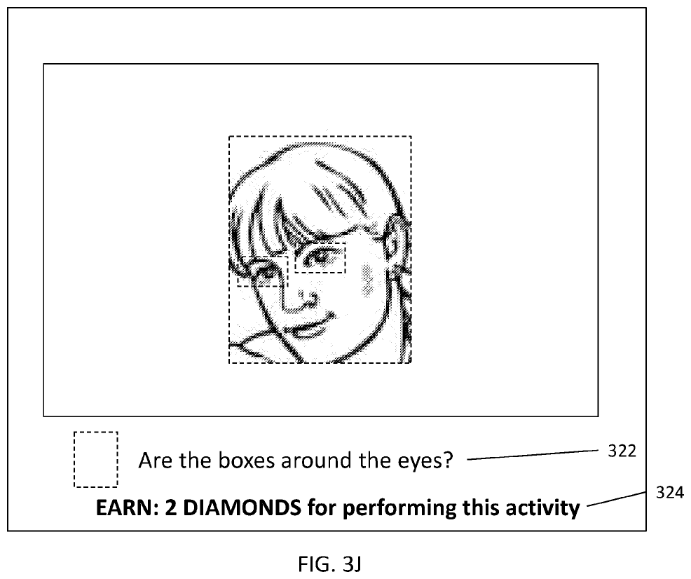

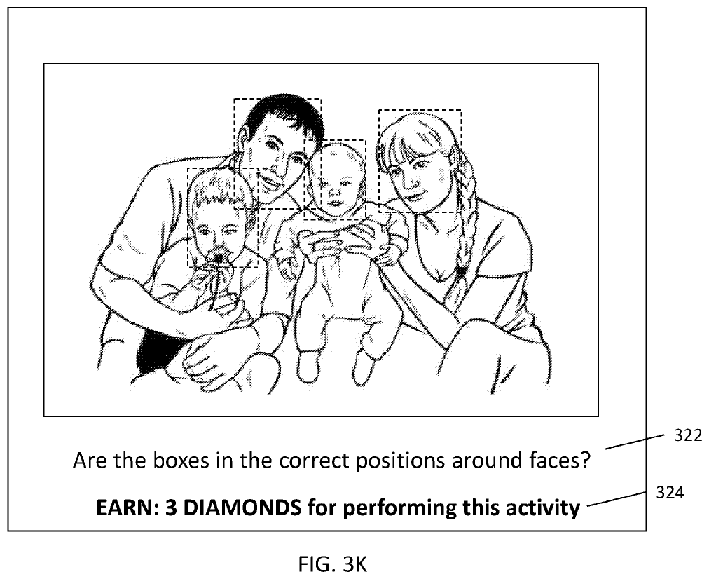

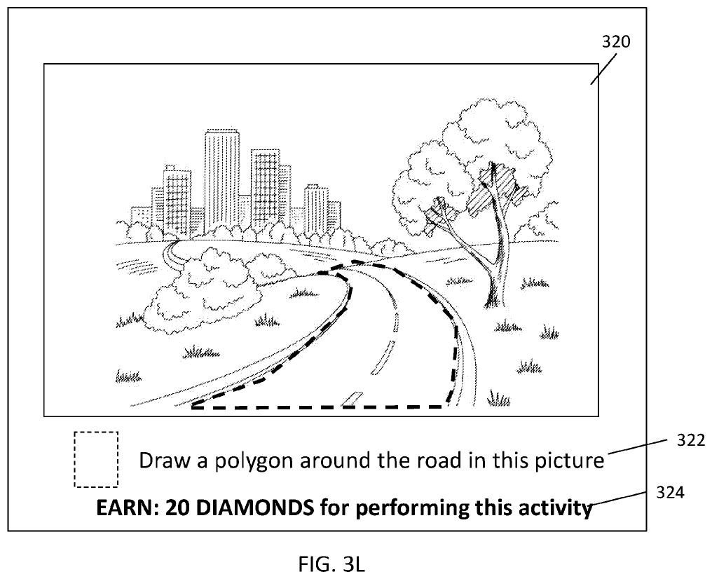

Reference is now made FIGS. 2A-2C showing a flow diagram and related screenshots describing the operation of a dataset annotation system and FIGS. 3A-3L showing exemplary screenshots related to the dataset annotation system according to at least some embodiments. FIG. 2A shows an example process 200 for annotating a dataset 52A. The description below of process 200 may be based on system 100 described with reference to FIG. 1. Reference to specific items (such as 20A, 130A) is made to enable clarity of the description below and should not be considered limiting.

The steps below are described with reference to a computing device that performs operations described at each step. The computing device can correspond to a computing device corresponding to DAS 100 and/or servers 116, 114 and/or clients 112, 113. Where process 200 refers to operation of DAS 100 this should be understood as referring to operation of the components of DAS 100 that may be controlled by controller service 121.

In step 202, dataset manager 124 receives a dataset 52A from client 50A. Client 50A also provides dataset requirements related to dataset 52A including but not limited to one or more of the domain of the dataset, the features required, the cost constraints, and the user skill set. In some embodiments, client 50A provides one or more annotated data parts 53 as samples. Where samples are provided, dataset manager 124 derives the dataset requirements from analysis of the sample annotated data parts 53.

In step 204, dataset manager stores the received dataset 52A in dataset database 128. Campaign manager 123 evaluates the number of tasks 130 vs. a cost budget provided by client 50 so as to determine approximate remuneration for users 20 per a defined number of tasks in order to remain within the provided budget. Campaign manager 123 determines the dataset parameters for use by annotator engine 122 such as maximum tasks to be performed. In some embodiments, DAS 100 generates a synthetic dataset and process 200 is performed using the generated synthetic dataset.

Annotator engine 122 then analyzes dataset 52A and divides dataset 52A into separate data parts 53. In step 206, annotator engine 122 breaks the annotation of each data part 53 into multiple tasks 130 as appropriate for the annotation required. In some embodiments, step 206 is performed using AI analysis by ML models 125 of annotator engine 122. In a non-limiting example, machine vision techniques are used when data parts 53 include images or videos in order to define annotation or verification tasks 130. In some embodiments, step 206 is performed manually by an operator of annotator engine 122 that reviews the data parts 53 and decides how these should be broken down into tasks 130.

FIGS. 2B-2C show examples of non-limiting GUI 240 for interaction with annotator engine 122 by an operator of annotator engine 122 for manual definition of annotation tasks. As shown in FIG. 2B, data parts 242-1, 242-2 to 242-n of a received dataset are shown to the operator. The operator can then define the task 244, here shown as a question, as well as the potential answers 246 to the question/task based on the dataset requirements. Thus, users will be shown vehicle photographs and be asked to identify the color of the vehicle. As shown in FIG. 2C, based on the data parts 248 and the dataset requirements an operator defines the task 250 as drawing a bounding box around a specific product shown in an image.

In some embodiments, a combination of AI analysis (ML models 125) and manual analysis by an operator is used for performing step 206.

The initial set of tasks 130 are macro-tasks and these are further broken down into sub-tasks and also verification tasks as the annotation progresses and according to the requirements of the annotation. The tasks 130 are packaged into a format that can be handled by distribution server 114. Annotator engine 122 tracks each data part 53 in each dataset 52 as well as the tasks 130 associated with each data part 53. In some embodiments, all data associated with each dataset 52 is stored in dataset database 128.

In step 210, annotator engine 122 defines the skill set required of potential annotators based on the annotation task defined in step 206. In some embodiments, distribution server 114 contains a database (not shown) of users 20, including user data, and user characteristics. In some embodiments, the database of users 20, including user data, user skill sets, and user ratings based on previous tasks completed, is stored in DAS 100. In some embodiments, in step 210 some of the tasks 130 are redirected to ML models 125 such as in annotator engine 122 for automatic annotation. Based on the skill set required, the time constraints and the skill level of user required, a suitable user or type of user 20 for performing an annotation or verification task is selected by campaign manager 123 from the users known to distribution server and/or DAS 100. In some embodiments, the actual user 20 or type of user is selected by distribution server 114. In some embodiments, the actual user 20 or type of user is selected by campaign manager 123.

In step 214, the task 130A is presented to the selected user 20A. As shown in FIGS. 3A and 3B, in a game 308 supported by advertising, the game is paused while an advertisement/introduction screen 310 is shown to user 20A offering a reward for performing task 130A. In some embodiments, the introduction screen includes an explanatory video or series of images explaining the task to be performed. Screen 310 is generated by distribution server 114 based on task data provided by DAS 100. In some embodiments, advertisement/introduction screen 310 is generated by annotator engine 122 for distribution by distribution server 114. Alternatively, where user 20A is using an app, the app pauses and the user is shown the task 130A in the advertisement screen 310. In some embodiments, the advertisement 310 contains one or more of the task description and an indication of the reward that will be provided to the user 20A if the task is successfully completed. In some embodiments, the initial task is a qualification task (as described below). In some embodiments, users 20 of annotator clients 113 are known annotators and are simply sent tasks 130 according to the user skill set and dataset 52 requirements.

FIGS. 3C-3E and 3I to 3L show exemplary tasks 130A for performing by user 20A. As shown in the non-limiting example of FIG. 3C, an image of a group of people is provided and the task instruction 322 indicates that the user 20A is required to tag the faces in image 320 by drawing bounding boxes around the faces in the picture. The tasks shown in FIGS. 3C-3E should not be considered limiting. FIGS. 3B, 3D and 3E illustrate tasks deployed for mobile devices thus expanding the range of users 20 that may perform tasks 130 since tasks 130 are structed by annotator engine 122 such that tasks 130 do not require dedicated workstation hardware. Task 130 may be any form of annotation task related to any type of data part 53, such as but not limited to visual feature in an image or video, sounds in an audio file or text styles in a document.

In some embodiments, task 130 may require drawing of polygons surrounding a specific item or area such as shown in FIGS. 3C-3E, and 3L. FIG. 3D shows a bounding box task before completion by a user 20 and FIG. 3E shows a bounding box task after completion by a user 20. In some embodiments, task 130 is a qualification task for determining the capability of a user to perform certain types of tasks and the time that will be taken to accurately perform these tasks. Qualification tasks may have a known solution to enable evaluation of the user's ability to complete the task successfully. In some embodiments, such as shown in FIG. 3K task 130 is a verification task for verifying that tasks performed by other users or ML processing were correctly performed.

In some embodiments, the reward indication 324 (FIG. 3C) is also provided to the user 20A and is related to the complexity and time required of the task. In FIG. 3C, the illustrative reward is an in-game reward of “diamonds” that have value in the game being played using game client 112A.

In step 216 the user 20A either performs the task 130A or rejects the task 130A. Where user 20A performs annotation, the completed task is passed back to annotator engine 122 for analysis. In some embodiments, such as shown in FIGS. 3G and 3H, feedback is provided to user 20 such as but not limited to a words of praise 330 and or a score 332. In step 218, if the annotation task 130A of the image was the final task required, then process 200 proceeds with step 222.

If the completed task 130 is not the final task, then process 200 proceeds with step 220. It should be appreciated that steps 210, 214, 216, and 218 are performed multiple times in parallel such that multiple users 20 can work on multiple annotation tasks 130 related to dataset 52A simultaneously, to therefore complete the annotation of dataset 52A more quickly than the time taken by one or a limited number of users. Further, users 20 can work on multiple tasks 130 divided based on skill set required and allocated to users 20 having appropriate skill sets. In some embodiments, several users will be assigned the same annotation task in steps 201, 214, 216 and 218, so as to evaluated as a group to obtain multiple independent judgements from which the majority or the average is selected.

If, in step 216, the user 20A does not perform the task 130A then steps 210 and 214 are repeated and another user 20B is selected for performing task 130A. If, in step 216, the user 20A performs task 130A then in step 217, user 20A is provided with the reward/remuneration associated with task 130A. In some embodiments, the reward is provided for completion of a defined number of tasks 130. Annotator engine 122 notifies payment manager 126 of the successful completion of task 130A as well as the related reward. Payment manager 126 interfaces with merchant 60 or game server 116 or annotator client 113 to provide the reward associated with completion of task 130A. As shown in a non-limiting form in FIG. 3F, the user 20A is notified of having received the reward for performing task 130A. Another non-limiting example of a reward includes a subscription such as for use of merchant app 118. Alternatively, the reward provided to user 20A may be unrelated to the game of game client 112 or app 118 and may be a monetary reward such as with fiat or virtual currency or other reward such as through a merchant 60 not associated with game client 112 or app 118. Further, having completed the task 130, user 20 is rated within Annotator engine 122 based on the type of task, the time taken and the verified completion. Users 20 with higher ratings and verified annotation specialties will be selected for appropriate future tasks. In some embodiments, other user factors are evaluated vs. the completed tasks to determine user ranking such as but not limited to user location, user time zone, and/or user responsiveness. Users 20 that reject tasks or have negative verification are lowered in rank and may be excluded from further task allocations.

In step 220, since the annotation is not yet complete, annotator engine 122 defines a further task 130B and additionally identifies a user 20B or type of user for performing task 130B. Optionally, user 20A may again be called upon to perform task 130B or any subsequent task. Task 130B may be a further annotation task similar to task 130. Alternatively, task 130B may use the annotation provided by user 20A and add a further sub-task to this annotation. As a non-limiting example, FIG. 3I shows annotation task 130B requiring identification of facial features based on the face segmentation performed in task 130A (FIG. 3C). Alternatively, task 130B may be a verification task to verify whether the annotation provided by user 20A was accurate such as illustrated in FIG. 3J, where task 130B is to verify that the face segmentation performed by user 20A in task 130A (FIG. 3I) was performed accurately. Where such a verification confirms that user 20A performed accurate annotation, annotator engine 122 records the performance of user 20A and may thus learn to trust the annotation work of user

Alternatively, as illustrated in FIG. 3K, annotator engine 122, performs ML based image analysis following the initial segmentation of task 130A to provide ML based annotation of a data part 53. In such a case, task 130B will include verification of the ML annotation performed by annotator engine 122.

Following the creation of task 130B, steps 214, 216, and 217 are repeated and step 218 is then repeated until all of the possible tasks 130 have been performed for the specific image. In step 222, the fully annotated and verified image is assembled and added to the annotated dataset 52A′ by annotator engine 122. The completed annotated dataset 52A′ is then returned by dataset manager to client 50A.

Payment manager 126 tracks the rewards and associated monetary value of all tasks 130 performed related to dataset 52A such that client 50A can be billed based on the actual cost of the complete annotation. In some embodiments, the actual cost is evaluated vs. the tasks allocated and/or the time taken for completion, such as by campaign manager 123, to determine the success of a remuneration campaign and/or remuneration type associated with a specific dataset. Alternatively, client 50A defines a maximum cost for annotation of dataset 52A and, when payment manager 126 determines that the maximum cost has been reached based on the rewards provided, the annotation of dataset 52A is stopped.

Unless otherwise defined, all technical and scientific terms used herein have the same meaning as commonly understood by one of ordinary skill in the art. The materials, methods, and examples provided herein are illustrative only and not intended to be limiting.

As used herein the terms “machine learning” or “artificial intelligence” refer to use of algorithms on a computing device that parse data, learn from the data, and then make a determination or generate data, where the determination or generated data is not deterministically replicable (such as with deterministically oriented software as known in the art).

Implementation of the method and system of the present disclosure may involve performing or completing certain selected tasks or steps manually, automatically, or a combination thereof. Moreover, according to actual instrumentation and equipment of preferred embodiments of the method and system of the present disclosure, several selected steps may be implemented by hardware (HW) or by software (SW) on any operating system of any firmware, or by a combination thereof. For example, as hardware, selected steps of the disclosure could be implemented as a chip or a circuit. As software or algorithm, selected steps of the disclosure could be implemented as a plurality of software instructions being executed by a computer using any suitable operating system. In any case, selected steps of the method and system of the disclosure could be described as being performed by a data processor, such as a computing device for executing a plurality of instructions.

As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

Although the present disclosure is described with regard to a “computing device”, a “computer”, or “mobile device”, it should be noted that optionally any device featuring a data processor and the ability to execute one or more instructions may be described as a computing device, including but not limited to any type of personal computer (PC), a server, a distributed server, a virtual server, a cloud computing platform, a cellular telephone, an IP telephone, a smartphone, a smart watch or a PDA (personal digital assistant). Any two or more of such devices in communication with each other may optionally comprise a “network” or a “computer network”.

To provide for interaction with a user, the systems and techniques described here can be implemented on a computer having a display device (a LED (light-emitting diode), or OLED (organic LED), or LCD (liquid crystal display) monitor/screen) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

It should be appreciated that the above described methods and apparatus may be varied in many ways, including omitting or adding steps, changing the order of steps and the type of devices used. It should be appreciated that different features may be combined in different ways. In particular, not all the features shown above in a particular embodiment or implementation are necessary in every embodiment or implementation of the invention. Further combinations of the above features and implementations are also considered to be within the scope of some embodiments or implementations of the invention.

While certain features of the described implementations have been illustrated as described herein, many modifications, substitutions, changes and equivalents will now occur to those skilled in the art. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

While the disclosure has been described with respect to a limited number of embodiments, it will be appreciated that many variations, modifications, and other applications of the disclosure may be made.

What is claimed is:

1. A non-transitory computer readable medium for annotating a dataset, the computer readable medium containing instructions that when executed by at least one processor, cause the at least one processor to perform a method, the method comprising:
a. dividing a dataset to be annotated into annotating tasks by an annotator engine;
b. distributing the annotating tasks to machine learning (ML) models and/or a plurality of selected users by a distribution server for completion of the annotating tasks; and
c. reassembling the completed annotation tasks into an annotated dataset.

2. The method of claim 1, wherein the selected users are playing a game and the annotation task is performed in-game.

3. The method of claim 1, wherein the selected users are using an app and the annotation task is performed in-app.

4. The method of claim 1, wherein the selected users are using an annotation application.

5. The method of claim 4, wherein the annotation application runs on a mobile device.

6. The method of claim 1, wherein the dividing of the dataset is performed by ML models.

7. The method of claim 1, wherein the dividing of the dataset is performed manually by an operator of the annotator engine.

8. The method of claim 1, wherein the task is a qualification task.

9. The method of claim 1, wherein the task is a verification task.

10. The method of claim 9 wherein the verification task comprises verifying the annotation performed by an ML model.

11. The method of claim 1, wherein the selected users are selected based on one or more of user type, user skill sets, or user ratings based on previous tasks completed.

12. The method of claim 2, wherein the task is presented to the selected user as part of in-game advertising.

13. The method of claim 3, wherein the task is presented to the selected user as part of in-app advertising.

14. The method of claim 1 wherein the same task is assigned to multiple selected users, wherein the annotations of the same task by the selected users are evaluated as a group by the annotation engine.

15. The method of claim 1, wherein tasks comprise microtasks.

16. The method of claim 1, wherein the dataset is provided with dataset requirements selected from the list including: a domain of the dataset, features required, cost constraints, time constraints, user skill set and a combination of the above.

17. The method of claim 16, wherein dataset parameters are determined by a campaign manager based on the dataset requirements, wherein the dataset parameters are one or more of user remuneration, time constraints, or maximum number of tasks.

18. The method of claim 1, further comprising remunerating each of the selected users that completes at least one annotation task.

19. The method of claim 18, wherein the user remuneration is an in-game reward.

20. The method of claim 18, wherein the user remuneration is an in-app reward.

21. The method of claim 18, wherein the user remuneration is a virtual currency.

22. The method of claim 1 wherein the selected user is rated based on a completed task.

23. The method of claim 1 wherein the task comprises identifying one or more of a visual feature in an image, a visual feature in a video, sounds in an audio file or text styles in a document.

24. The method of claim 21 wherein the identifying one or more visual features comprises one or more of drawing a polygon, drawing a bounding box, selecting the feature.

25. A system comprising a dataset annotation system (DAS), the DAS further including:
a. an annotator engine configured for dividing a dataset to be annotated into annotating tasks; and
b. a distribution server configured for distributing the annotating tasks to machine learning (ML) models and/or a plurality of selected users for completion of the annotating tasks,
wherein the DAS is further configured for reassembling the completed annotation tasks into an annotated dataset.

26. The system of claim 25, wherein the annotation task is performed within games played by the plurality of selected users.

27. The system of claim 25, further comprising an app and wherein the annotation task is performed in-app.

28. The system of claim 4, wherein the app runs on a mobile device.

29. The system of claim 25, wherein the dividing of the dataset is performed by ML models.

30. The system of claim 25, wherein the dividing of the dataset is performed manually by an operator of the annotator engine.

31. The system of claim 25, wherein the task is a qualification task.

32. The system of claim 25, wherein the task is a verification task.

33. The system of claim 32, wherein the verification task comprises verifying the annotation performed by an ML model.

34. The system of claim 25, wherein the dataset is a synthetic dataset.

35. The system of claim 25, wherein the selected users are selected based on one or more of user type, user skill sets, or user ratings based on previous tasks completed.

36. The system of claim 26, wherein the task is presented to the selected user as part of in-game advertising.

37. The system of claim 27, wherein the task is presented to the selected user as part of in-app advertising.

38. The system of claim 25, wherein the same task is assigned to multiple selected users, wherein the annotations of the same task by the selected users are evaluated as a group by the annotation engine.

39. The system of claim 25, wherein tasks comprise microtasks.

40. The system of claim 25, wherein the dataset is provided with dataset requirements selected from the list including: a domain of the dataset, features required, cost constraints, time constraints, user skill set and a combination of the above.

41. The system of claim 16, wherein dataset parameters are determined by a campaign manager based on the dataset requirements, wherein the dataset parameters are one or more of user remuneration, time constraints, or maximum number of tasks.

42. The system of claim 25, wherein each of the selected users that completes at least one annotation task is remunerated.

43. The system of claim 42, wherein the user remuneration is an in-game reward.

44. The system of claim 42, wherein the user remuneration is an in-app reward.

45. The system of claim 42, wherein the user remuneration is a virtual currency.

46. The system of claim 25, wherein the selected user is rated based on a completed task.

47. The system of claim 25, wherein the task includes identifying one or more of a visual feature in an image, a visual feature in a video, sounds in an audio file or text styles in a document.

48. The system of claim 47 wherein the identifying one or more visual features includes one or more of drawing a polygon, drawing a bounding box, and/or selecting the feature.
